(19) United States
(12) Patent Application Publication
(10) Pub. No.: US 2026/0017916 A1
(43) Pub. Date: Jan. 15, 2026

(54) OCCUPANT PHYSIQUE DETECTION DEVICE AND OCCUPANT PHYSIQUE DETECTION METHOD

(71) Applicant: Mitsubishi Electric Corporation, Tokyo (JP)

(72) Inventors: Daiki ICHIKAWA, Tokyo (JP); Naoya BABA, Tokyo (JP); Hirotaka SAKAMOTO, Tokyo (JP)

(73) Assignee: Mitsubishi Electric Corporation, Tokyo (JP)

(21) Appl. No.: 19/113,731

(22) PCT Filed: Nov. 14, 2022
(86) PCT No.: PCT/JP2022/042157

§ 371 Date: Mar. 20, 2025

(51) Int. Cl. G06V 10/34; G06V 20/59; G06V 40/10

(52) U.S. Cl. CPC G06V 10/34; G06V 20/59; G06V 40/10

(57) ABSTRACT

An occupant physique detection device includes: a captured image acquiring unit that acquires a captured image, from a camera that images the occupant of a vehicle; a skeletal point detecting unit that detects, from the captured image, three skeletal points that have no obstacles between the camera and the skeletal points and can be used to estimate the physique of the occupant among five predetermined skeletal points including the skeletal points of both shoulder portions and the skeletal points of both waist portions of the occupant, and outputs the position coordinates of each of the three skeletal points in the captured image; an area calculating unit that calculates the area of a polygon having each skeletal point as a vertex, using the position coordinates of each of the skeletal points; and a physique estimating unit that estimates the physique of the occupant from the area of the polygon.

### TECHNICAL FIELD

The present disclosure relates to an occupant physique detection device and an occupant physique detection method.

### BACKGROUND ART

There are occupant physique detection devices that detect the physique of an occupant of a vehicle, on the basis of a captured image in which the occupant is captured.

As such an occupant physique detection device, Patent Literature 1 discloses a device including an acquisition unit, a calculation unit, and a determination unit.

The acquisition unit acquires a captured image showing an occupant of a vehicle, from a camera that images the occupant. The calculation unit detects each of the skeletal points of both shoulder portions and both waist portions of the occupant from the captured image acquired by the acquisition unit, and calculates the area of the trunk of the occupant from position coordinates of each of the skeletal points in the captured image. The area of the trunk is the area of the body portion of the occupant. The determination unit determines the physique of the occupant from the area of the trunk calculated by the calculation unit.

### CITATION LIST

### Patent Literature

Patent Literature 1: JP 2018-96946 A

### SUMMARY OF INVENTION

### Technical Problem

An occupant in a vehicle is normally seated in a seat. Accordingly, the posture of an occupant is often a seated posture. In a case where the posture of the occupant is a seated posture, occlusion may occur in which one of the skeletal points of the shoulder portions or the skeletal points of the waist portions is blocked by, for example, a forearm portion of the occupant, a hand of the occupant, a thigh of the occupant, or baggage, depending on the installation position of the camera.

In the occupant physique detection device disclosed in Patent Literature 1, there is a problem in that the determination unit cannot determine the physique of an occupant, because the calculation unit cannot detect one or more of the four skeletal points unless all of the four skeletal points, which are the skeletal points of both shoulder portions and the skeletal points of both waist portions, are in a detectable state.

The present disclosure has been made to solve the above problems, and aims to obtain an occupant physique detection device capable of increasing the number of states of an occupant from which the physique of the occupant can be estimated to a larger number than that in a conventional case.

### Solution to Problem

An occupant physique detection device according to the present disclosure includes: a captured image acquiring unit that acquires a captured image showing an occupant, from a camera that images the occupant of a vehicle; and a skeletal point detecting unit that detects, from the captured image acquired by the captured image acquiring unit, three or more skeletal points that are skeletal points having no obstacles between them and the camera and can be used to estimate the physique of the occupant among five or more predetermined skeletal points including the skeletal points of both shoulder portions and the skeletal points of both waist portions of the occupant, and outputs the position coordinates of each of the three or more skeletal points in the captured image. Also, the occupant physique detection device includes: an area calculating unit that calculates the area of a polygon having each skeletal point as a vertex, using the position coordinates of each of the skeletal points output from the skeletal point detecting unit; and a physique estimating unit that estimates the physique of the occupant from the area of the polygon calculated by the area calculating unit.

### Advantageous Effects of Invention

According to the present disclosure, it is possible to increase the number of states of an occupant from which the physique of the occupant can be estimated, to a larger number than that in a conventional case.

### BRIEF DESCRIPTION OF DRAWINGS

FIG. 1 is a configuration diagram illustrating an occupant physique detection device 2 according to a first embodiment.

FIG. 2 is a hardware configuration diagram showing the hardware of the occupant physique detection device 2 according to the first embodiment.

FIG. 3 is a hardware configuration diagram of a computer in a case where the occupant physique detection device 2 is implemented by software, firmware, or the like.

FIG. 4 is a flowchart showing an occupant physique detection method that includes processing procedures to be carried out by the occupant physique detection device 2.

FIG. 5 is an explanatory diagram illustrating an example of a captured image in which an occupant is captured.

FIG. 6 is an explanatory diagram illustrating a correspondence relationship between an area S of a triangle and a physique P.

FIG. 7 is an explanatory diagram illustrating an example of control on an airbag or the like corresponding to the physique P of the occupant.

FIG. 8 is a configuration diagram illustrating an occupant physique detection device 2 according to a second embodiment.

FIG. 9 is a hardware configuration diagram showing the hardware of the occupant physique detection device 2 according to the second embodiment.

FIG. 10 is an explanatory diagram illustrating a state in which the occupant keeps the occupant's own arms down.

FIG. 11 is an explanatory diagram illustrating a state in which the occupant raises the occupant's own arm in the width direction of the vehicle.

FIG. 12 is an explanatory diagram illustrating a state in which the occupant raises the occupant's own arm in the width direction of the vehicle.

FIG. 13 is a configuration diagram illustrating an occupant physique detection device 2 according to a third embodiment.

FIG. 14 is a hardware configuration diagram showing the hardware of the occupant physique detection device 2 according to the third embodiment.

FIG. 15 is an explanatory diagram illustrating a state in which the occupant keeps the occupant's own arms down.

FIG. 16 is an explanatory diagram illustrating a state in which the occupant raises the occupant's own at least one arm in the traveling direction.

FIG. 17 is a configuration diagram illustrating an occupant physique detection device 2 according to a fourth embodiment.

FIG. 18 is a hardware configuration diagram showing the hardware of the occupant physique detection device 2 according to the fourth embodiment.

FIG. 19 is an explanatory diagram illustrating a state in which the occupant keeps the occupant's own arms down.

FIG. 20 is a configuration diagram illustrating an occupant physique detection device 2 according to a fifth embodiment.

FIG. 21 is a hardware configuration diagram showing the hardware of the occupant physique detection device 2 according to the fifth embodiment.

FIG. 22 is an explanatory diagram illustrating a state in which an occupant is seated on a side closer to the rear window of the vehicle than the appropriate position in calculating the area S of a triangle.

### DESCRIPTION OF EMBODIMENTS

To explain the present disclosure in greater detail, modes for carrying out the disclosure are described below with reference to the accompanying drawings.

### First Embodiment

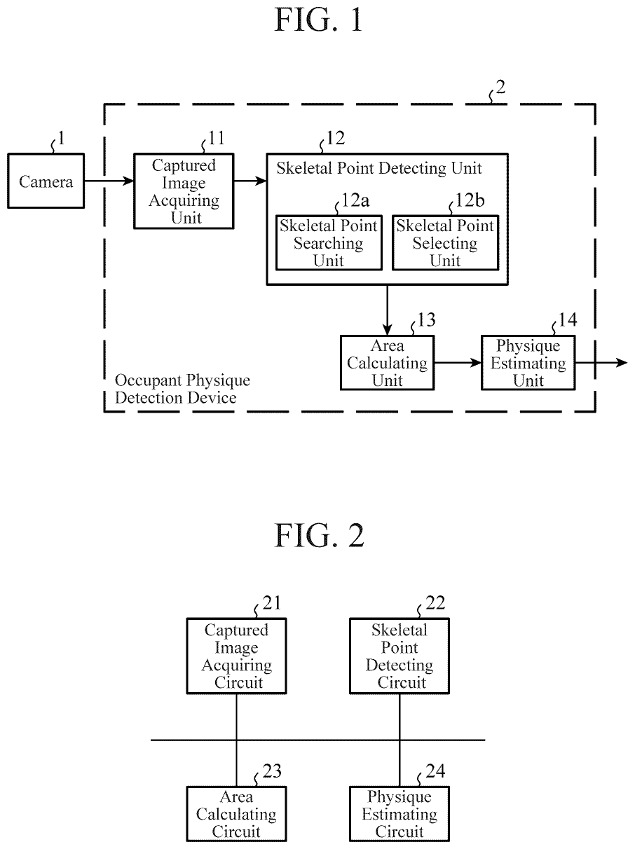

FIG. 1 is a configuration diagram showing an occupant physique detection device 2 according to a first embodiment.

FIG. 2 is a hardware configuration diagram showing the hardware of the occupant physique detection device 2 according to the first embodiment.

In FIG. 1, a camera 1 is implemented by a video camera, an infrared camera, a visible light camera, or an ultraviolet camera, for example.

The camera 1 is disposed near the center of the dashboard in the width direction of a vehicle or near the center of the ceiling of the vehicle in the width direction of the vehicle, for example.

The camera 1 captures an image of an occupant of the vehicle, and outputs image data indicating a captured image in which the occupant is captured to the occupant physique detection device 2.

The installation position of the camera 1 is not limited to the vicinity of the center of the dashboard or the like, but may be a position facing the driver's seat or a position facing the front passenger seat in the dashboard.

The occupant physique detection device 2 includes a captured image acquiring unit 11, a skeletal point detecting unit 12, an area calculating unit 13, and a physique estimating unit 14.

The occupant physique detection device 2 is a device that estimates the physique of an occupant, on the basis of the captured image indicated by image data.

The captured image acquiring unit 11 is implemented by a captured image acquiring circuit 21 shown in FIG. 2, for example.

The captured image acquiring unit 11 acquires, from the camera 1, the image data indicating the captured image in which the occupant is captured.

The captured image acquiring unit 11 outputs the image data to the skeletal point detecting unit 12.

The skeletal point detecting unit 12 is implemented by a skeletal point detecting circuit 22 shown in FIG. 2, for example.

The skeletal point detecting unit 12 includes a skeletal point searching unit 12a and a skeletal point selecting unit 12b.

The skeletal point detecting unit 12 acquires the image data from the captured image acquiring unit 11.

The skeletal point detecting unit 12 detects, from the captured image indicated by the image data, three or more skeletal points that are skeletal points having no obstacles between them and the camera 1 and can be used for estimating the physique of the occupant among five or more predetermined skeletal points including the skeletal points of both shoulder portions and the skeletal points of both waist portions of the occupant.

A skeletal point having no obstacles between it and the camera 1 is a skeletal point at which no occlusion has occurred. As for the skeletal points of the waist portions, for example, a forearm of the occupant, a hand of the occupant, a thigh of the occupant, baggage, or the like can be an obstacle. As for the skeletal points of the shoulder portions, for example, a hand of the occupant, baggage, or the like can be an obstacle. As for the skeletal points of the elbow portions, for example, the body of the occupant, baggage, or the like can be an obstacle.

Examples of the predetermined five or more skeletal points include a skeletal point of the left shoulder portion, a skeletal point of the right shoulder portion, a skeletal point of the left waist portion, a skeletal point of the right waist portion, a skeletal point of the elbow portion of the left arm, a skeletal point of the elbow portion of the right arm, a midpoint between the left clavicle portion and the right clavicle portion (this midpoint will be hereinafter referred to as the “first midpoint”), and a midpoint between the skeletal point of the left shoulder portion and the skeletal point of the right shoulder portion (this midpoint will be hereinafter referred to as the “second midpoint”).

The first midpoint is a point on a line segment connecting the right end of the left clavicle portion and the left end of the right clavicle portion, and is a position at which the distance from the right end of the left clavicle portion and the distance from the left end of the right clavicle portion are equal. Note that the first midpoint is not limited to the position at which the distances are strictly equal, but may be a position shifted from the position at which the distances are equal within a range that does not cause any problem in practice.

The second midpoint is a point on a line segment connecting the skeletal point of the left shoulder portion and the skeletal point of the right shoulder portion, and is a position at which the distance from the skeletal point of the left shoulder portion and the distance from the skeletal point of the right shoulder portion are substantially equal. Note that the second midpoint is not limited to the position at which the distances are strictly equal, but may be a position shifted from the position at which the distances are equal within a range that does not cause any problem in practice.

The skeletal point detecting unit 12 outputs position coordinates of each of the three or more skeletal points in the captured image to the area calculating unit 13.

Of the occupant physique detection device 2 shown in FIG. 1, a configuration in which the skeletal point detecting unit 12 detects three skeletal points is described herein, for ease of explanation. Note that this is merely an example, and the skeletal point detecting unit 12 may detect four or more skeletal points, and output position coordinates of each of the four or more skeletal points in the captured image to the area calculating unit 13.

The skeletal point searching unit 12a searches for, from the captured image indicated by the image data, three or more skeletal points that are skeletal points having no obstacles between them and the camera 1 and can be used for estimating the physique of the occupant among five or more predetermined skeletal points including the skeletal points of both shoulder portions and the skeletal points of both waist portions of the occupant.

The skeletal point selecting unit 12b selects three skeletal points from among the three or more skeletal points searched for by the skeletal point searching unit 12a, and outputs the position coordinates of each of the selected three skeletal points in the captured image to the area calculating unit 13.

The area calculating unit 13 is implemented by an area calculating circuit 23 shown in FIG. 2, for example.

The area calculating unit 13 acquires the position coordinates of each of the three or more skeletal points from the skeletal point detecting unit 12.

The area calculating unit 13 calculates the area of a polygon having the skeletal points as the vertices, using the position coordinates of each of the skeletal points.

The area calculating unit 13 outputs the result of the area calculation to the physique estimating unit 14.

In the occupant physique detection device 2 shown in FIG. 1, the skeletal point detecting unit 12 detects three skeletal points that can be used for estimation of the occupant physique, and outputs the position coordinates of each of the three skeletal points to the area calculating unit 13, for ease of explanation. In this case, the area calculating unit 13 calculates the area of a triangle as the area of a polygon having the skeletal points as the vertices, using the position coordinates of each of the skeletal points.

Note that, in a case where the skeletal point detecting unit 12 outputs position coordinates of each of four skeletal points to the area calculating unit 13, for example, the area calculating unit 13 calculates the area of a quadrangle having the four skeletal points as the vertices. In a case where the skeletal point detecting unit 12 outputs position coordinates of five skeletal points to the area calculating unit 13, for example, the area calculating unit 13 calculates the area of a pentagon having the five skeletal points as the vertices.

The physique estimating unit 14 is implemented by a physique estimating circuit 24 shown in FIG. 2, for example.

The physique estimating unit 14 acquires the result of the area calculation from the area calculating unit 13.

The physique estimating unit 14 estimates the physique of the occupant from the area indicated by the calculation result.

In FIG. 1, it is assumed that each of the captured image acquiring unit 11, the skeletal point detecting unit 12, the area calculating unit 13, and the physique estimating unit 14, which are components of the occupant physique detection device 2, is implemented by dedicated hardware as illustrated in FIG. 2. That is, it is assumed that the occupant physique detection device 2 is implemented by the captured image acquiring circuit 21, the skeletal point detecting circuit 22, the area calculating circuit 23, and the physique estimating circuit 24.

Each of the captured image acquiring circuit 21, the skeletal point detecting circuit 22, the area calculating circuit 23, and the physique estimating circuit 24 is a single circuit, a composite circuit, a programmed processor, a parallel-programmed processor, an application specific integrated circuit (ASIC), a field-programmable gate array (FPGA), or a combination thereof, for example.

The components of the occupant physique detection device 2 are not necessarily formed with dedicated hardware, but the occupant physique detection device 2 may be implemented by software, firmware, or a combination of software and firmware.

Software or firmware is stored as a program in a memory of a computer. A computer means hardware that executes a program, and is a central processing unit (CPU), a graphics processing unit (GPU), a central processor, a processing unit, an arithmetic unit, a microprocessor, a microcomputer, a processor, or a digital signal processor (DSP), for example.

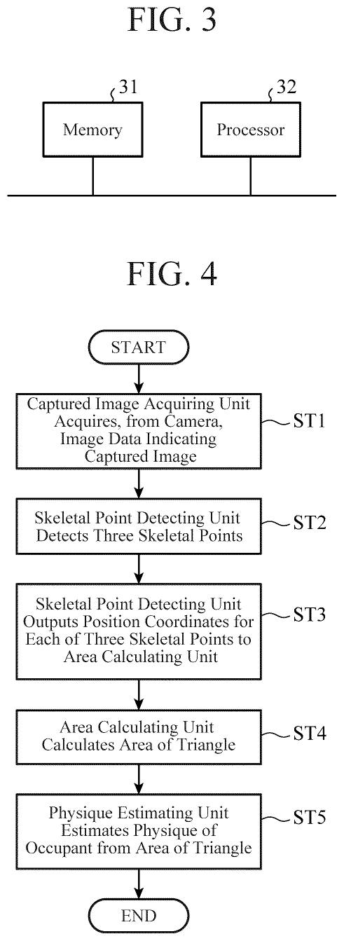

FIG. 3 is a hardware configuration diagram of a computer in a case where the occupant physique detection device 2 is implemented by software, firmware, or the like.

In a case where the occupant physique detection device 2 is implemented by software, firmware, or the like, a program for causing a computer to carry out the processing procedure in each of the captured image acquiring unit 11, the skeletal point detecting unit 12, the area calculating unit 13, and the physique estimating unit 14 is stored in a memory 31. A processor 32 of the computer then executes the program stored in the memory 31.

Further, FIG. 2 illustrates an example in which each of the components of the occupant physique detection device 2 is implemented by dedicated hardware, and FIG. 3 illustrates an example in which the occupant physique detection device 2 is implemented by software, firmware, or the like. Note that this is merely an example, and some components in the occupant physique detection device 2 may be implemented by dedicated hardware while the remaining components may be implemented by software, firmware, or the like.

Next, an operation of the occupant physique detection device 2 shown in FIG. 1 is described.

A physique generally means a state of the external appearance of a body. For example, a physical measurement value of height, weight, or chest circumference represents the size of the body as a state of the external appearance of the body. For this reason, these physical measurement values can be indices of the physique.

Since the area of the body portion of the occupant also represents the size of the body, the area of the body portion can be an index of the physique. It can be said that, the larger the area of the body portion, the larger the physique. The area of the body portion of the occupant is substantially the area of the quadrangle surrounded by the skeletal point of the left shoulder portion, the skeletal point of the right shoulder portion, the skeletal point of the left waist portion, and the skeletal point of the right waist portion of the occupant. Accordingly, each of the skeletal point of the left shoulder portion, the skeletal point of the right shoulder portion, the skeletal point of the left waist portion, and the skeletal point of the right waist portion is a skeletal point that can be used for estimating the physique of the occupant.

The length of the upper arm is normally proportional to the height, and the upper arm of a taller person tends to be longer. Therefore, the length of the upper arm can be an index of the physique in the same manner as the height and the like. The length of the upper arm is the length between the skeletal point of the shoulder portion and the skeletal point of the elbow portion.

Since the length of the upper arm can be an index of the physique, an area proportional to the length of the upper arm, or specifically, the area of the quadrangle surrounded by the skeletal point of the left shoulder portion, the skeletal point of the right shoulder portion, the skeletal point of the elbow portion of the left arm, and the skeletal point of the elbow portion of the right arm can also be an index of the physique. It can be said that, the larger the area of the quadrangle, the larger the physique. Accordingly, each of the skeletal point of the left shoulder portion, the skeletal point of the right shoulder portion, the skeletal point of the elbow portion of the left arm, and the skeletal point of the elbow portion of the right arm is a skeletal point that can be used for estimating the physique of the occupant.

For the same reason, the area of the triangle surrounded by the skeletal point of the left shoulder portion, the skeletal point of the right shoulder portion, and the skeletal point of the elbow portion of the left arm or the skeletal point of the elbow portion of the right arm can also be an index of the physique. The area of the triangle is approximately half the area of the quadrangle described above, and it can be said that, the larger the area of the triangle, the larger the physique. Accordingly, the skeletal point of the left shoulder portion, the skeletal point of the right shoulder portion, and the skeletal point of the elbow portion of the left arm or the skeletal point of the elbow portion of the right arm are skeletal points that can be used for estimating the physique of the occupant.

Also, for the same reason, the area of the triangle surrounded by the skeletal point of the left shoulder portion or the skeletal point of the right shoulder portion, the skeletal point of the elbow portion of the left arm or the skeletal point of the elbow portion of the right arm of the occupant, and the first midpoint can also be an index of the physique. The area of the triangle is approximately half the area of the quadrangle described above, and it can be said that, the larger the area of the triangle, the larger the physique. Accordingly, the skeletal point of the left shoulder portion or the skeletal point of the right shoulder portion, the skeletal point of the elbow portion of the left arm or the skeletal point of the elbow portion of the right arm of the occupant, and the first midpoint are skeletal points that can be used for estimating the physique of the occupant.

Note that, in a case where the right end of the left clavicle portion is searched for as a skeletal point, and the left end of the right clavicle portion is searched for as a skeletal point, the first midpoint can be detected.

Also, for the same reason, the area of the triangle surrounded by the skeletal point of the left shoulder portion or the skeletal point of the right shoulder portion, the skeletal point of the elbow portion of the left arm or the skeletal point of the elbow portion of the right arm of the occupant, and the second midpoint can also be an index of the physique. The area of the triangle is approximately half the area of the quadrangle described above, and it can be said that, the larger the area of the triangle, the larger the physique. The skeletal point of the left shoulder portion or the skeletal point of the right shoulder portion, the skeletal point of the elbow portion of the left arm or the skeletal point of the elbow portion of the right arm, and the second midpoint are skeletal points that can be used for estimating the physique of the occupant.

Note that, in a case where the skeletal point of the left shoulder portion is searched for, and the skeletal point of the right shoulder portion is searched for, the second midpoint can be detected.

In a case where only one of the skeletal point of the left shoulder portion and the skeletal point of the right shoulder portion has been searched for, if the distance in the vertical direction between the skeletal point of the searched shoulder portion and the first midpoint is calculated, the position on the lower side in the vertical direction than the first midpoint by the distance can be detected as the second midpoint.

FIG. 4 is a flowchart showing an occupant physique detection method that includes processing procedures to be carried out by the occupant physique detection device 2.

The camera 1 captures an image of an occupant of a vehicle.

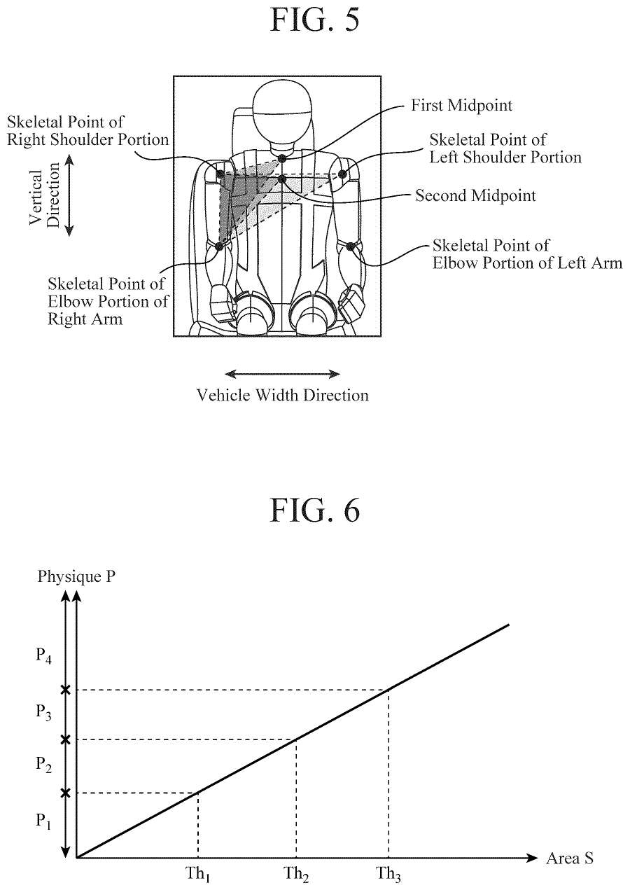

The camera 1 outputs image data indicating a captured image as shown in FIG. 5, for example, to the occupant physique detection device 2.

FIG. 5 is an explanatory diagram illustrating an example of a captured image in which an occupant is captured.

The captured image illustrated in FIG. 5 shows the upper body and part of the lower body of the occupant. Specifically, the captured image illustrated in FIG. 5 shows the shoulder portions, the elbow portions, the clavicle portions, and the chest portion of the occupant.

In the example in FIG. 5, since the waist portions of the occupant are blocked by the thigh portions of the occupant, it may be difficult to detect the skeletal points of the waist portions. In this case, the thigh portions of the occupant are obstacles that are present between the camera 1 and the waist portions.

Note that, in a case where the occupant sitting in the front passenger seat or the like largely reclines the seat, the waist portions of the occupant are hardly blocked by the thigh portions, and therefore, there is a possibility that the skeletal points of the waist portions will be detected.

The captured image acquiring unit 11 of the occupant physique detection device 2 acquires, from the camera 1, the image data indicating the captured image (step ST1 in FIG. 4).

The captured image acquiring unit 11 outputs the image data to the skeletal point detecting unit 12.

The skeletal point detecting unit 12 acquires the image data from the captured image acquiring unit 11.

The skeletal point detecting unit 12 detects, from the captured image indicated by the image data, three skeletal points that are skeletal points having no obstacles between them and the camera 1 and can be used for estimating the physique of the occupant among five or more predetermined skeletal points including the skeletal points of both shoulder portions and the skeletal points of both waist portions of the occupant (step ST2 in FIG. 4).

The skeletal point detecting unit 12 outputs the position coordinates of each of the three skeletal points in the captured image to the area calculating unit 13 (step ST3 in FIG. 4).

In the description below, a skeletal point detecting process to be performed by the skeletal point detecting unit 12 is specifically explained.

The skeletal point searching unit 12a searches for, from the captured image indicated by the image data, three or more skeletal points that can be used for estimating the physique of the occupant, among five or more predetermined skeletal points including the skeletal points of both shoulder portions and the skeletal points of both waist portions of the occupant.

Since the skeletal point searching process is a known technique, a detailed explanation thereof is not made herein. As a known technique, there is a skeleton estimating technique called “Open Pose”, for example.

In the example in FIG. 5, the skeletal point of the left shoulder portion, the skeletal point of the right shoulder portion, the skeletal point of the elbow portion of the left arm, the skeletal point of the elbow portion of the right arm, the first midpoint, and the second midpoint are searched for as the three or more skeletal points that can be used for estimating the physique of the occupant.

The skeletal point selecting unit 12b selects three skeletal points that can be used to estimate the physique of the occupant, from among the three or more skeletal points searched for by the skeletal point searching unit 12a.

Specifically, the skeletal point selecting unit 12b selects, from among the three or more skeletal points, one of the skeletal point of the left shoulder portion and the skeletal point of the right shoulder portion as a first skeletal point.

In a case where the distance from the camera 1 to the left shoulder portion is shorter than the distance from the camera 1 to the right shoulder portion, for example, the skeletal point selecting unit 12b selects the skeletal point of the left shoulder portion as the first skeletal point.

In a case where the distance from the camera 1 to the left shoulder portion is longer than the distance from the camera 1 to the right shoulder portion, for example, the skeletal point selecting unit 12b selects the skeletal point of the right shoulder portion as the first skeletal point.

In a case where the vehicle is a right-hand drive vehicle, the occupant is the driver, and the camera 1 is disposed near the center of the dashboard in the width direction of the vehicle, for example, the distance from the camera 1 to the left shoulder portion is shorter than the distance from the camera 1 to the right shoulder portion.

In a case where the vehicle is a right-hand drive vehicle, the occupant is the person in the front passenger seat, and the camera 1 is disposed near the center of the dashboard in the width direction of the vehicle, for example, the distance from the camera 1 to the left shoulder portion is longer than the distance from the camera 1 to the right shoulder portion.

Next, the skeletal point selecting unit 12b selects, from among the three or more skeletal points, one of the skeletal point of the elbow portion of the left arm and the skeletal point of the elbow portion of the right arm as a second skeletal point.

In a case where the skeletal point of the left shoulder portion has been selected as the first skeletal point, for example, the skeletal point selecting unit 12b selects the skeletal point of the elbow portion of the left arm as the second skeletal point. In a case where the skeletal point of the right shoulder portion has been selected as the first skeletal point, for example, the skeletal point selecting unit 12b selects the skeletal point of the elbow portion of the right arm as the second skeletal point.

Here, in a case where the skeletal point of the left shoulder portion has been selected as the first skeletal point, for example, the skeletal point selecting unit 12b selects the skeletal point of the elbow portion of the left arm as the second skeletal point. Note that this is merely an example, and the skeletal point selecting unit 12b may select the skeletal point of the elbow portion of the right arm as the second skeletal point. In a case where the skeletal point of the elbow portion of the left arm is blocked by baggage, for example, the skeletal point selecting unit 12b selects the skeletal point of the elbow portion of the right arm as the second skeletal point.

Here, in a case where the skeletal point of the right shoulder portion has been selected as the first skeletal point, the skeletal point selecting unit 12b selects the skeletal point of the elbow portion of the right arm as the second skeletal point. Note that this is merely an example, and the skeletal point selecting unit 12b may select the skeletal point of the elbow portion of the left arm as the second skeletal point. In a case where the skeletal point of the elbow portion of the right arm is blocked by baggage, for example, the skeletal point selecting unit 12b selects the skeletal point of the elbow portion of the left arm as the second skeletal point.

Next, the skeletal point selecting unit 12b selects, as a third skeletal point from among the three or more skeletal points, the first midpoint, the second midpoint, or the skeletal point of the left shoulder portion and the skeletal point of the right shoulder portion, whichever has not been selected as the first skeletal point (this point will be hereinafter referred to as the “unselected shoulder skeletal point”).

The skeletal point to be selected as the third skeletal point may be any one of the first midpoint, the second midpoint, and the unselected shoulder skeletal point.

In a case where priorities are set for the first midpoint, the second midpoint, and the unselected shoulder skeletal point, the skeletal point selecting unit 12b can use a selection method for preferentially selecting the skeletal point having the highest priority.

For example, it is assumed that the priority of the unselected shoulder skeletal point is higher than the priority of the first midpoint, and the priority of the first midpoint is higher than the priority of the second midpoint.

In this case, if the unselected shoulder skeletal point has been searched for by the skeletal point searching unit 12a, the skeletal point selecting unit 12b selects the unselected shoulder skeletal point as the third skeletal point.

In a case where the unselected shoulder skeletal point has not been searched for by the skeletal point searching unit 12a, if the first midpoint has been searched for, the skeletal point selecting unit 12b selects the first midpoint as the third skeletal point. In a case where the unselected shoulder skeletal point is blocked by baggage or the like, the unselected shoulder skeletal point is not searched for by the skeletal point searching unit 12a.

In a case where both the unselected shoulder skeletal point and the first midpoint have not been searched for by the skeletal point searching unit 12a, if the second midpoint has been searched for, the skeletal point selecting unit 12b selects the second midpoint as the third skeletal point. In a case where the right end of the left clavicle portion or the left end of the right clavicle portion is blocked by baggage or the like, the first midpoint is not searched for by the skeletal point searching unit 12a.

For example, it is assumed that the priority of the first midpoint is higher than the priority of the second midpoint, and the priority of the second midpoint is higher than the priority of the unselected shoulder skeletal point.

In this case, if the first midpoint has been searched for by the skeletal point searching unit 12a, the skeletal point selecting unit 12b selects the first midpoint as the third skeletal point.

In a case where the first midpoint has not been searched for by the skeletal point searching unit 12a, if the second midpoint has been searched for, the skeletal point selecting unit 12b selects the second midpoint as the third skeletal point.

In a case where both the first midpoint and the second midpoint have not been searched for by the skeletal point searching unit 12a, if the unselected shoulder skeletal point has been searched for, the skeletal point selecting unit 12b selects the unselected shoulder skeletal point as the third skeletal point. In a case where either the skeletal point of the left shoulder portion or the skeletal point of the right shoulder portion has not been searched for, and the first midpoint has not been searched for, the second midpoint is not searched for by the skeletal point searching unit 12a.

Lastly, the skeletal point selecting unit 12b outputs the position coordinates of each of the first skeletal point, the second skeletal point, and the third skeletal point to the area calculating unit 13.

In the example in FIG. 5, the skeletal point of the left shoulder portion, the skeletal point of the right shoulder portion, the skeletal point of the elbow portion of the left arm, the skeletal point of the elbow portion of the right arm, the first midpoint, and the second midpoint have been searched for. Note that this is merely an example, and the skeletal point of the left waist portion or the skeletal point of the right waist portion may be searched for, for example.

In a case where the skeletal point of the left waist portion or the skeletal point of the right waist portion has been searched for, the skeletal point selecting unit 12b may select the skeletal point of the left waist portion or the skeletal point of the right waist portion as the second skeletal point, for example.

The area calculating unit 13 acquires, from the skeletal point detecting unit 12, the position coordinates of each of the first skeletal point, the second skeletal point, and the third skeletal point.

Using the position coordinates, the area calculating unit 13 calculates an area S of the triangle having the first skeletal point, the second skeletal point, and the third skeletal point as the vertices (step ST4 in FIG. 4).

The area calculating unit 13 outputs the result of the calculation of the area S to the physique estimating unit 14.

The physique estimating unit 14 acquires the result of the calculation of the area S from the area calculating unit 13.

The physique estimating unit 14 estimates a physique P of the occupant from the area S of the triangle indicated by the calculation result (step ST5 in FIG. 4).

As described above, the area S of the triangle can be an index of the physique. Therefore, the physique estimating unit 14 may output the area S as an index indicating the physique. Here, to qualitatively distinguish the physique P of the occupant, the physique estimating unit 14 classifies the physique P of the occupant into N levels on the basis of the area S of the triangle. N is an integer of 2 or greater.

The physique estimating unit 14 outputs the result of the estimation of the physique P to a control device (not shown) of the vehicle, for example. The control device of the vehicle is a device that adjusts the tensile strength of a seat belt of the vehicle, or the output strength of an airbag of the vehicle, for example.

In the description below, a physique estimating process to be performed by the physique estimating unit 14 is specifically explained.

In a case where the physique estimating unit 14 classifies the physique P of the occupant into N levels, the physique estimating unit 14 has (N−1) thresholds Thₙ (n=1, . . . , N−1). The thresholds Thₙ are thresholds related to the area S of the triangle, and are stored in an internal memory in the physique estimating unit 14, for example. The thresholds Thₙ may be given from the outside of the occupant physique detection device 2.

$${Th}_{1} < {Th}_{2} < … < T {h}_{N - 2} < T {h}_{N - 1}$$

The physique estimating unit 14 compares the area S of the triangle with the (N−1) thresholds Thₙ (n=1, . . . , N−1).

As shown below, the physique estimating unit 14 estimates the physique P of the occupant, on the basis of the results of the comparison between the area S and the thresholds Thₙ.

Note that the area S of the triangle in a case where the first skeletal point is the skeletal point of the right shoulder portion, the second skeletal point is the skeletal point of the elbow portion of the right arm, and the third skeletal point is the skeletal point of the left shoulder portion is different from the area S of the triangle in a case where the first skeletal point is the skeletal point of the right shoulder portion, the second skeletal point is the skeletal point of the elbow portion of the right arm, and the third skeletal point is the first midpoint, for example.

That is, even for the same occupant, the area S of the triangle varies with each possible combination of the first skeletal point, the second skeletal point, and the third skeletal point. Accordingly, the correspondence relationship between the area S and the physique P varies with each possible combination, and therefore, the (N−1) thresholds Thₙ that vary with each possible combination are stored in the internal memory in the physique estimating unit 14.

| Comparison result | Physique |
|---|---|
| S < Th₁ | → P₁ |
| Th₁ ≤ S < Th₂ | → P₂ |
| Th₂ ≤ S < Th₃ | → P₃ |
| Th₃ ≤ S < Th₄ | → P₄ |
| | . |
| | . |
| | . |
| Thₙ₋₂ ≤ S < Thₙ₋₁ | → P_{N-1} |
| Thₙ₋₁ ≤ S | → P_{N} |

P₁ < P₂ < . . . < P_{N-1} < P_{N}

FIG. 6 is an explanatory diagram illustrating the correspondence relationship between the area S of the triangle and the physique P.

FIG. 6 shows that the area S and the physique P are correlated, the horizontal axis indicates the area S of the triangle, and the vertical axis indicates the physique P of the occupant.

In the example in FIG. 6, the physique P of the occupant is classified into one of P₁, P₂, P₃, and P₄, on the basis of the area S.

In the occupant physique detection device 2 shown in FIG. 1, the physique estimating unit 14 estimates the physique P of the occupant, on the basis of a result of comparison between the area S and the thresholds Thₙ. Even in a case where the area S calculated by the area calculating unit 13 is the area of a polygon other than a triangle, there is a correspondence relationship between the area of the polygon and the physique P. Accordingly, the physique estimating unit 14 can estimate the physique P of the occupant by comparing the area S of the polygon other than a triangle with the thresholds Thₙ.

Further, in the occupant physique detection device 2 shown in FIG. 1, the physique estimating unit 14 estimates the physique P of the occupant, on the basis of a result of comparison between the area S and the thresholds Thₙ. Note that this is merely an example, and the physique estimating unit 14 may calculate the physique P from the area S, as shown below in Expression (1), for example.

$$P = α \times S \qquad ( 1 )$$

In Expression (1), a represents a proportional constant greater than 1, for example.

The control device (not shown) of the vehicle acquires the result of estimation of the physique P from the physique estimating unit 14.

As for the control at a time when a collision of the vehicle occurs, for example, the control device of the vehicle controls the tensile strength of the seat belt at a time of occurrence of the collision, in addition to the size of the airbag that is inflated at the time of occurrence of the collision.

As the control device controls each of the size of the airbag and the tensile strength of the seat belt on the basis of the result of the estimation of the physique P, it is possible to reduce the damage on the occupant at a time of occurrence of a collision.

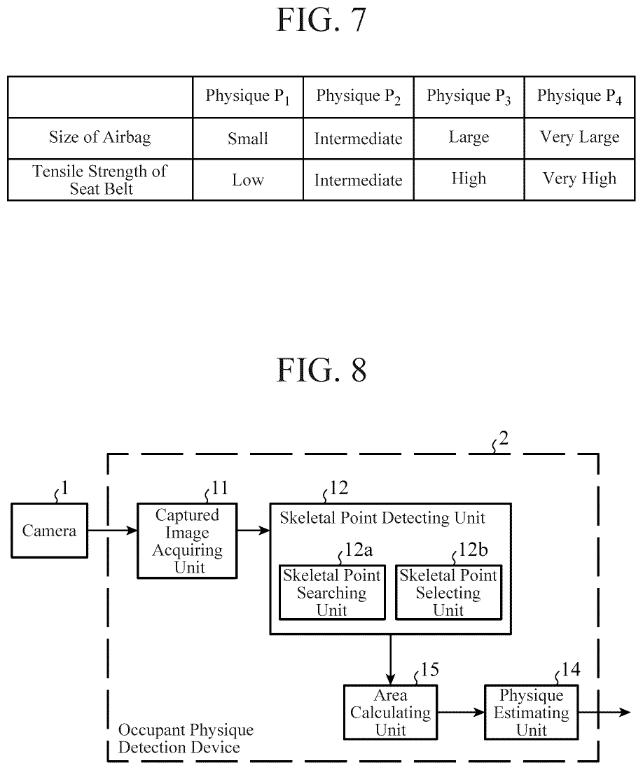

FIG. 7 is an explanatory diagram illustrating an example of control on the airbag or the like corresponding to the physique P of the occupant.

The example in FIG. 7 shows that, the larger the physique P of the occupant, the larger the size of the inflated airbag and the higher the tensile strength of the seat belt.

In the first embodiment described so far, the occupant physique detection device 2 is configured in such a manner as to include: the captured image acquiring unit 11 that acquires a captured image showing an occupant of a vehicle, from the camera 1 that images the occupant; and the skeletal point detecting unit 12 that detects, from the captured image acquired by the captured image acquiring unit 11, three or more skeletal points that are skeletal points having no obstacles between them and the camera 1 and can be used to estimate the physique of the occupant among five or more predetermined skeletal points including the skeletal points of both shoulder portions and the skeletal points of both waist portions of the occupant, and outputs the position coordinates of each of the three or more skeletal points in the captured image. Also, the occupant physique detection device 2 includes: the area calculating unit 13 that calculates the area of a polygon having each skeletal point as a vertex, using the position coordinates of each of the skeletal points output from the skeletal point detecting unit 12; and the physique estimating unit 14 that estimates the physique of the occupant, from the area of the polygon calculated by the area calculating unit 13. Thus, the occupant physique detection device 2 can increase the number of states of an occupant from which the physique of the occupant can be estimated, to a larger number than that in a conventional case.

### Second Embodiment

A second embodiment describes an occupant physique detection device 2 including an area calculating unit 15 that calculates the area S of a triangle, using position coordinates of each of a first skeletal point, a second skeletal point, and a third skeletal point, only in a case where an angle θₐ formed by a first straight line L₁ and a second straight line L₂ is within an allowable angular range.

The first straight line L₁ is the straight line connecting the first skeletal point and the second skeletal point, and the second straight line L₂ is the straight line connecting the first skeletal point and the third skeletal point.

In the occupant physique detection device 2 according to the second embodiment, in a case where the first skeletal point is the skeletal point of the left shoulder portion of the occupant, the second skeletal point is the skeletal point of the elbow portion of the left arm of the occupant. In a case where the first skeletal point is the skeletal point of the right shoulder portion of the occupant, the second skeletal point is the skeletal point of the elbow portion of the right arm of the occupant.

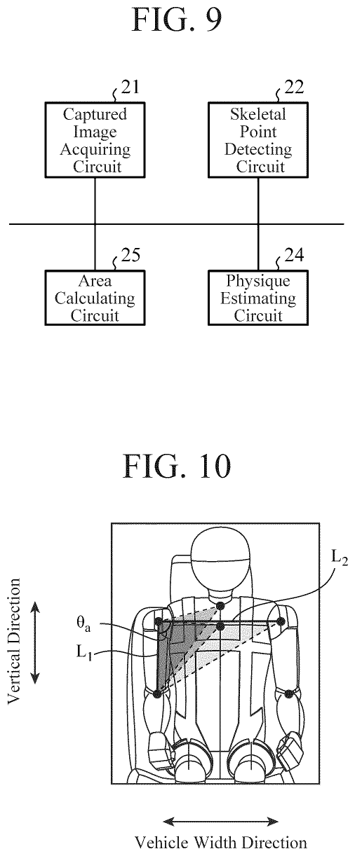

FIG. 8 is a configuration diagram showing the occupant physique detection device 2 according to the second embodiment. In FIG. 8, the same reference numerals as those in FIG. 1 denote the same or corresponding components, and therefore, explanation of them is not made herein.

FIG. 9 is a hardware configuration diagram showing the hardware of the occupant physique detection device 2 according to the second embodiment. In FIG. 9, the same reference numerals as those in FIG. 2 denote the same or corresponding components, and therefore, explanation of them is not made herein.

The area calculating unit 15 is implemented by an area calculating circuit 25 shown in FIG. 9, for example.

The area calculating unit 15 acquires the position coordinates of each of the three skeletal points from the skeletal point detecting unit 12.

Using the position coordinates of each of the skeletal points, the area calculating unit 15 calculates the area of the triangle having the skeletal points as the vertices.

Here, only in a case where the angle θₐ formed by the first straight line L₁ and the second straight line L₂ is within the allowable angular range, does the area calculating unit 15 calculate the area S of the triangle, using the position coordinates of each of the first skeletal point, the second skeletal point, and the third skeletal point. Therefore, in a case where the angle θₐ is out of the allowable angular range, the area calculating unit 15 does not perform the process of calculating the area S of the triangle.

The area calculating unit 15 outputs the result of the calculation of the area S to the physique estimating unit 14.

In FIG. 8, it is assumed that each of the captured image acquiring unit 11, the skeletal point detecting unit 12, the area calculating unit 15, and the physique estimating unit 14, which are components of the occupant physique detection device 2, is implemented by dedicated hardware as illustrated in FIG. 9. That is, it is assumed that the occupant physique detection device 2 is implemented by the captured image acquiring circuit 21, the skeletal point detecting circuit 22, the area calculating circuit 25, and the physique estimating circuit 24.

Each of the captured image acquiring circuit 21, the skeletal point detecting circuit 22, the area calculating circuit 25, and the physique estimating circuit 24 is a single circuit, a composite circuit, a programmed processor, a parallel-programmed processor, an ASIC, an FPGA, or a combination thereof, for example.

The components of the occupant physique detection device 2 are not necessarily implemented by dedicated hardware, but the occupant physique detection device 2 may be implemented by software, firmware, or a combination of software and firmware.

In a case where the occupant physique detection device 2 is formed with software, firmware, or the like, a program for causing a computer to carry out the processing procedure in each of the captured image acquiring unit 11, the skeletal point detecting unit 12, the area calculating unit 15, and the physique estimating unit 14 is stored in the memory 31 shown in FIG. 3. The processor 32 shown in FIG. 3 then executes the program stored in the memory 31.

Further, FIG. 9 illustrates an example in which each of the components of the occupant physique detection device 2 is implemented by dedicated hardware, and FIG. 3 illustrates an example in which the occupant physique detection device 2 is implemented by software, firmware, or the like. Note that this is merely an example, and some components in the occupant physique detection device 2 may be implemented by dedicated hardware while the remaining components may be implemented by software, firmware, or the like.

Next, an operation of the occupant physique detection device 2 shown in FIG. 8 is described. Except for the area calculating unit 15, the occupant physique detection device 2 is the same as the occupant physique detection device 2 shown in FIG. 1. Therefore, only the operation of the area calculating unit 15 is described herein.

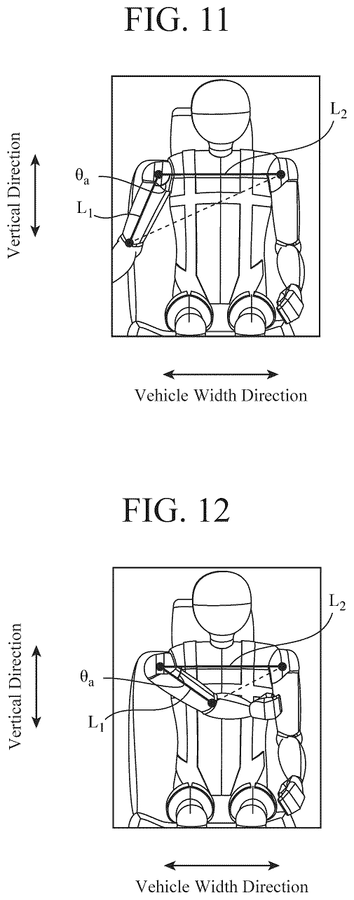

In a case where the occupant keeps the occupant's own arms down as illustrated in FIG. 10, the angle θₐ formed by the first straight line L₁ and the second straight line L₂ is an angle close to 90 degrees. The angle θₐ is the angle formed by the first straight line L₁ and the second straight line L₂ in a two-dimensional plane between the width direction of the vehicle and the vertical direction of the vehicle (this plane will be hereinafter referred to as the “first plane”).

FIG. 10 is an explanatory diagram illustrating a state in which the occupant keeps the occupant's own arms down.

FIG. 10 illustrates an example in which the third skeletal point is the skeletal point of the left shoulder portion.

In a case where the occupant raises the occupant's own arm in the width direction of the vehicle as illustrated in FIG. 11, the angle θₐ formed by the first straight line L₁ and the second straight line L₂ changes to an angle larger than 90 degrees in the first plane. The area S of the triangle at this point of time may be smaller than the area S in the state where the arms are kept down.

Further, as illustrated in FIG. 12, in a case where the occupant raises the occupant's own arm in the direction opposite from the direction shown in FIG. 11, the angle θₐ formed by the first straight line L₁ and the second straight line L₂ changes to an angle smaller than 90 degrees in the first plane. The area S of the triangle at this point of time may be smaller than the area S in the state where the arms are kept down.

In a case where the occupant raises the occupant's own arm, the area S becomes smaller, and therefore, the area S of the triangle may fail to accurately represent the physique P of the occupant.

Each of FIGS. 11 and 12 is an explanatory diagram illustrating a state in which the occupant raises the occupant's own arm in the width direction of the vehicle.

FIGS. 11 and 12 each illustrate an example in which the third skeletal point is the skeletal point of the left shoulder portion.

The area calculating unit 15 acquires, from the skeletal point detecting unit 12, the position coordinates of each of the first skeletal point, the second skeletal point, and the third skeletal point.

The area calculating unit 15 holds information indicating the allowable angular range. The allowable angular range is from θ_{L} to θ_{H}. θ_{L} represents an angle smaller than 90 degrees, and θ_{H} represents an angle larger than 90 degrees.

From the position coordinates of each of the skeletal points, the area calculating unit 15 identifies the first straight line L₁ connecting the first skeletal point and the second skeletal point, and identifies the second straight line L₂ connecting the first skeletal point and the third skeletal point.

The area calculating unit 15 then obtains the angle θₐ formed by the first straight line L₁ and the second straight line L₂, and determines whether the angle θₐ is within the allowable angular range.

In a case where the angle θₐ is within the allowable angular range, the area calculating unit 15 calculates the area S of the triangle using the position coordinates, and outputs the result of the calculation of the area S to the physique estimating unit 14.

In a case where the angle θₐ is out of the allowable angular range, the area calculating unit 15 does not perform the process of calculating the area S of the triangle. In this case, the process of estimating the physique P by the physique estimating unit 14 is not performed.

In the second embodiment described so far, the occupant physique detection device 2 shown in FIG. 8 is configured in such a manner that, when the first skeletal point selected by the skeletal point selecting unit 12b is the skeletal point of the left shoulder portion of the occupant while the second skeletal point is the skeletal point of the elbow portion of the left arm of the occupant, or when the first skeletal point selected by the skeletal point selecting unit 12b is the skeletal point of the right shoulder portion of the occupant while the second skeletal point is the skeletal point of the elbow portion of the right arm of the occupant, the area calculating unit 15 calculates the area of the triangle having the first skeletal point, the second skeletal point, and the third skeletal point as the vertices, using the position coordinates of each of the first skeletal point, the second skeletal point, and the third skeletal point, only in a case where the angle formed by the first straight line connecting the first skeletal point and the second skeletal point and the second straight line connecting the first skeletal point and the third skeletal point is within the allowable angular range. Thus, like the occupant physique detection device 2 shown in FIG. 1, the occupant physique detection device 2 shown in FIG. 8 can increase the number of states of the occupant from which the physique of the occupant can be estimated to a larger number than that in a conventional case, and also can avoid the process of estimating of the physique in a state with a low estimation accuracy.

### Third Embodiment

A third embodiment describes an occupant physique detection device 2 including an area calculating unit 16 that calculates the area S of a triangle, using position coordinates of each of a first skeletal point, a second skeletal point, and a third skeletal point, only in a case where an angle θ_{b} formed by a first straight line L₁ and a third straight line L₃ is equal to or larger than a first threshold Th₁.

The third straight line L₃ is the straight line connecting the wrist of the arm in which the skeletal point selected as the second skeletal point is present and the second skeletal point.

In the occupant physique detection device 2 according to the third embodiment, in a case where the first skeletal point is the skeletal point of the left shoulder portion of the occupant, the second skeletal point is the skeletal point of the elbow portion of the left arm of the occupant. In a case where the first skeletal point is the skeletal point of the right shoulder portion of the occupant, the second skeletal point is the skeletal point of the elbow portion of the right arm of the occupant.

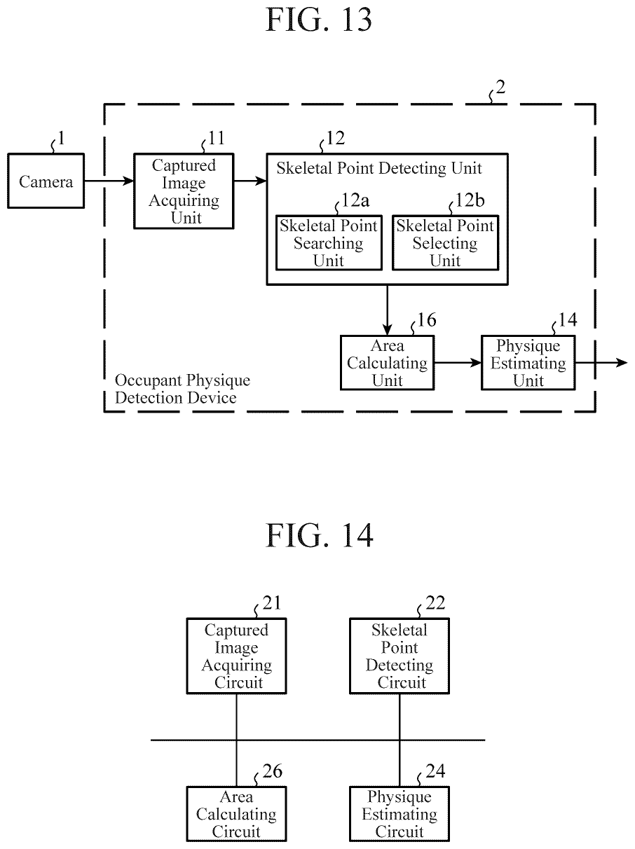

FIG. 13 is a configuration diagram showing the occupant physique detection device 2 according to the third embodiment. In FIG. 13, the same reference numerals as those in FIG. 1 denote the same or corresponding components, and therefore, explanation of them is not made herein.

FIG. 14 is a hardware configuration diagram showing the hardware of the occupant physique detection device 2 according to the third embodiment. In FIG. 14, the same reference numerals as those in FIG. 2 denote the same or corresponding components, and therefore, explanation of them is not made herein.

The area calculating unit 16 is implemented by an area calculating circuit 26 shown in FIG. 14, for example.

The area calculating unit 16 acquires the position coordinates of each of the three skeletal points from the skeletal point detecting unit 12.

Using the position coordinates of each of the skeletal points, the area calculating unit 16 calculates the area S of the triangle having the skeletal points as the vertices.

Here, only in a case where the angle θb formed by the first straight line L₁ and the third straight line L₃ is equal to or larger than the first threshold Th₁, does the area calculating unit 16 calculate the area S of the triangle, using the position coordinates of each of the first skeletal point, the second skeletal point, and the third skeletal point. Therefore, in a case where the angle θb is smaller than the first threshold Th₁, the area calculating unit 16 does not perform the process of calculating the area S of the triangle.

The area calculating unit 13 outputs the result of the calculation of the area S to the physique estimating unit 14.

In FIG. 13, it is assumed that each of the captured image acquiring unit 11, the skeletal point detecting unit 12, the area calculating unit 16, and the physique estimating unit 14, which are components of the occupant physique detection device 2, is formed with dedicated hardware as illustrated in FIG. 14. That is, it is assumed that the occupant physique detection device 2 is implemented by the captured image acquiring circuit 21, the skeletal point detecting circuit 22, the area calculating circuit 26, and the physique estimating circuit 24.

Each of the captured image acquiring circuit 21, the skeletal point detecting circuit 22, the area calculating circuit 26, and the physique estimating circuit 24 is a single circuit, a composite circuit, a programmed processor, a parallel-programmed processor, an ASIC, an FPGA, or a combination thereof, for example.

The components of the occupant physique detection device 2 are not necessarily implemented by dedicated hardware, but the occupant physique detection device 2 may be implemented by software, firmware, or a combination of software and firmware.

In a case where the occupant physique detection device 2 is implemented by software, firmware, or the like, a program for causing a computer to carry out the processing procedure in each of the captured image acquiring unit 11, the skeletal point detecting unit 12, the area calculating unit 16, and the physique estimating unit 14 is stored in the memory 31 shown in FIG. 3. The processor 32 shown in FIG. 3 then executes the program stored in the memory 31.

Further, FIG. 14 illustrates an example in which each of the components of the occupant physique detection device 2 is implemented by dedicated hardware, and FIG. 3 illustrates an example in which the occupant physique detection device 2 is implemented by software, firmware, or the like. Note that this is merely an example, and some components in the occupant physique detection device 2 may be implemented by dedicated hardware while the remaining components may be implemented by software, firmware, or the like.

Next, an operation of the occupant physique detection device 2 shown in FIG. 13 is described. Except for the area calculating unit 16, the occupant physique detection device 2 is the same as the occupant physique detection device 2 shown in FIG. 1. Therefore, only the operation of the area calculating unit 16 is described herein.

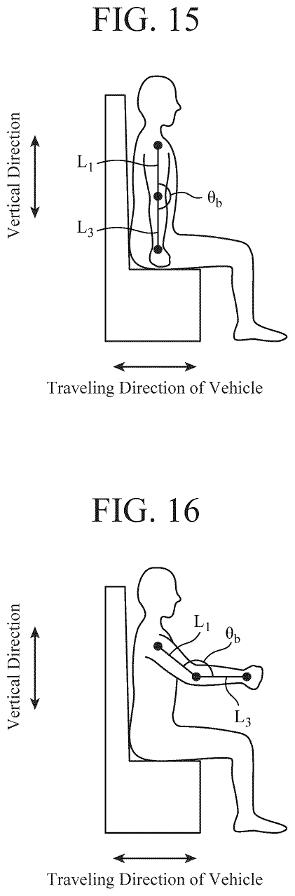

In a case where the occupant keeps the occupant's own arms down as illustrated in FIG. 15, the angle θ_{b} formed by the first straight line L₁ and the third straight line L₃ is an angle close to 180 degrees. The angle θ_{b} is the angle formed by the first straight line L₁ and the third straight line L₃ in a two-dimensional plane between the traveling direction of the vehicle and the vertical direction of the vehicle (this plane will be hereinafter referred to as the “second plane”).

FIG. 15 is an explanatory diagram illustrating a state in which the occupant keeps the occupant's own arms down.

In a case where the occupant raises the occupant's own at least one arm in the traveling direction of the vehicle as illustrated in FIG. 16, the angle θ_{b} formed by the first straight line L₁ and the third straight line L₃ may be an angle smaller than 180 degrees in the second plane. The area S of the triangle at this point of time may be smaller than the area S in the state where the arms are kept down.

In a case where the occupant raises the occupant's own at least one arm in the traveling direction, the area S becomes smaller, and therefore, the area S of the triangle may fail to accurately represent the physique P of the occupant.

FIG. 16 is an explanatory diagram illustrating a state in which the occupant raises the occupant's own at least one arm in the traveling direction.

The area calculating unit 16 acquires, from the skeletal point detecting unit 12, the position coordinates of each of the first skeletal point, the second skeletal point, and the third skeletal point.

The area calculating unit 16 holds information indicating the first threshold Th₁.

From the position coordinates of the skeletal points, the area calculating unit 16 identifies the first straight line L₁ connecting the first skeletal point and the second skeletal point, and identifies the third straight line L₃ connecting the wrist of the arm portion in which the skeletal point selected as the second skeletal point is present and the second skeletal point.

The area calculating unit 16 then obtains the angle θ_{b} formed by the first straight line L₁ and the third straight line L₃, and determines whether the angle θ_{b} is equal to or larger than the first threshold Th₁.

In a case where the installation position of the camera 1 is near the center of the dashboard in the width direction of the vehicle, for example, the camera 1 images the occupant obliquely with respect to the traveling direction of the vehicle. Accordingly, the area calculating unit 16 can obtain the angle θ_{b}, on the basis of the captured image indicated by the image data output from the camera 1.

In a case where the angle θ_{b} is equal to or larger than the first threshold Th₁, the area calculating unit 16 calculates the area S of the triangle using the position coordinates, and outputs the result of the calculation of the area S to the physique estimating unit 14.

In a case where the angle θ_{b} is smaller than the first threshold Th₁, the area calculating unit 16 does not perform the process of calculating the area S of the triangle. In this case, the process of estimating the physique P by the physique estimating unit 14 is not performed.

In the third embodiment described so far, the occupant physique detection device 2 shown in FIG. 13 is configured in such a manner that, when the first skeletal point selected by the skeletal point selecting unit 12b is the skeletal point of the left shoulder portion of the occupant while the second skeletal point is the skeletal point of the elbow portion of the left arm of the occupant, or when the first skeletal point selected by the skeletal point selecting unit 12b is the skeletal point of the right shoulder portion of the occupant while the second skeletal point is the skeletal point of the elbow portion of the right arm of the occupant, the area calculating unit 16 calculates the area of the triangle having the first skeletal point, the second skeletal point, and the third skeletal point as the vertices, using the position coordinates of each of the first skeletal point, the second skeletal point, and the third skeletal point, only in a case where the angle formed by the first straight line connecting the first skeletal point and the second skeletal point and the third straight line connecting the wrist of the arm in which the skeletal point selected as the second skeletal point is present and the second skeletal point is equal to or larger than the first threshold. Thus, like the occupant physique detection device 2 shown in FIG. 1, the occupant physique detection device 2 shown in FIG. 13 can increase the number of states of the occupant from which the physique of the occupant can be estimated to a larger number than that in a conventional case, and also can avoid the process of estimating of the physique in a state with a low estimation accuracy.

### Fourth Embodiment

A fourth embodiment describes an occupant physique detection device 2 including an area calculating unit 17 that calculates the area S of a triangle, using position coordinates of each of a first skeletal point, a second skeletal point, and a third skeletal point, only in a case where the ratio of the distance D₂ between the first skeletal point and the second skeletal point in a captured image to the distance D₃ between the first skeletal point and the third skeletal point in the captured image is equal to or higher than a second threshold Th₂.

In the occupant physique detection device 2 according to the fourth embodiment, in a case where the first skeletal point is the skeletal point of the left shoulder portion of the occupant, the second skeletal point is the skeletal point of the elbow portion of the left arm of the occupant. In a case where the first skeletal point is the skeletal point of the right shoulder portion of the occupant, the second skeletal point is the skeletal point of the elbow portion of the right arm of the occupant.

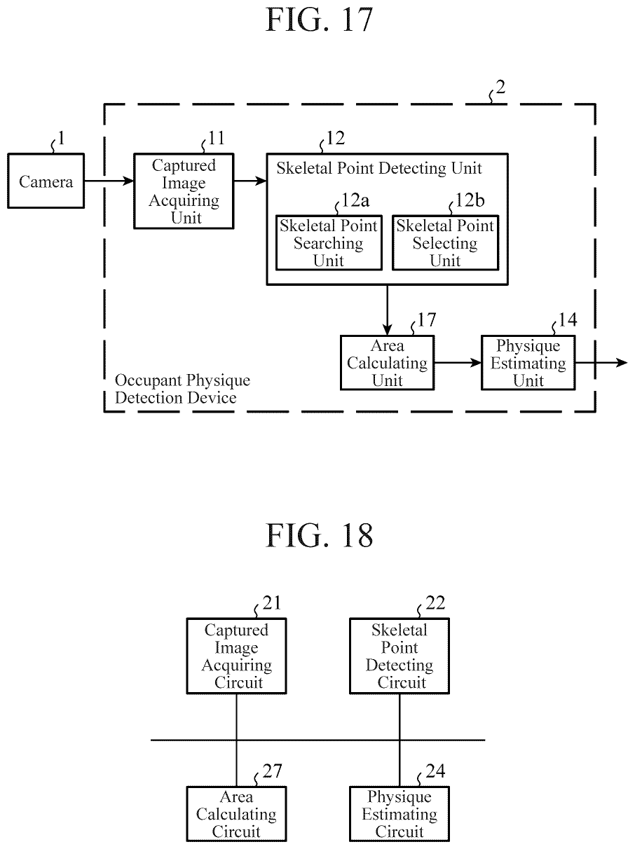

FIG. 17 is a configuration diagram showing the occupant physique detection device 2 according to the fourth embodiment. In FIG. 17, the same reference numerals as those in FIG. 1 denote the same or corresponding components, and therefore, explanation of them is not made herein.

FIG. 18 is a hardware configuration diagram showing the hardware of the occupant physique detection device 2 according to the fourth embodiment. In FIG. 18, the same reference numerals as those in FIG. 2 denote the same or corresponding components, and therefore, explanation of them is not made herein.

The area calculating unit 17 is implemented by an area calculating circuit 27 shown in FIG. 18, for example.

The area calculating unit 17 acquires the position coordinates of each of the three skeletal points from the skeletal point detecting unit 12.

Using the position coordinates of each of the skeletal points, the area calculating unit 17 calculates the area S of the triangle having the skeletal points as the vertices.

Here, only in a case where the ratio of the distance D₂ between the first skeletal point and the second skeletal point in a captured image to the distance D₃ between the first skeletal point and the third skeletal point in the captured image is equal to or higher than the second threshold Th₂, does the area calculating unit 17 calculate the area S of the triangle, using the position coordinates of each of the first skeletal point, the second skeletal point, and the third skeletal point. Therefore, in a case where the ratio of the distance D₂ to the distance D₃ is smaller than the second threshold Th₂, the area calculating unit 17 does not perform the process of calculating the area S of the triangle.

The area calculating unit 17 outputs the result of the calculation of the area S to the physique estimating unit 14.

In FIG. 17, it is assumed that each of the captured image acquiring unit 11, the skeletal point detecting unit 12, the area calculating unit 17, and the physique estimating unit 14, which are components of the occupant physique detection device 2, is implemented by dedicated hardware as illustrated in FIG. 18. That is, it is assumed that the occupant physique detection device 2 is implemented by the captured image acquiring circuit 21, the skeletal point detecting circuit 22, the area calculating circuit 27, and the physique estimating circuit 24.

Each of the captured image acquiring circuit 21, the skeletal point detecting circuit 22, the area calculating circuit 27, and the physique estimating circuit 24 is a single circuit, a composite circuit, a programmed processor, a parallel-programmed processor, an ASIC, an FPGA, or a combination thereof, for example.

The components of the occupant physique detection device 2 are not necessarily implemented by dedicated hardware, but the occupant physique detection device 2 may be implemented by software, firmware, or a combination of software and firmware.

In a case where the occupant physique detection device 2 is implemented by software, firmware, or the like, a program for causing a computer to carry out the processing procedure in each of the captured image acquiring unit 11, the skeletal point detecting unit 12, the area calculating unit 17, and the physique estimating unit 14 is stored in the memory 31 shown in FIG. 3. The processor 32 shown in FIG. 3 then executes the program stored in the memory 31.

Further, FIG. 18 illustrates an example in which each of the components of the occupant physique detection device 2 is implemented by dedicated hardware, and FIG. 3 illustrates an example in which the occupant physique detection device 2 is implemented by software, firmware, or the like. Note that this is merely an example, and some components in the occupant physique detection device 2 may be implemented by dedicated hardware while the remaining components may be implemented by software, firmware, or the like.

Next, an operation of the occupant physique detection device 2 shown in FIG. 17 is described. Except for the area calculating unit 17, the occupant physique detection device 2 is the same as the occupant physique detection device 2 shown in FIG. 1. Therefore, only the operation of the area calculating unit 17 is described herein.

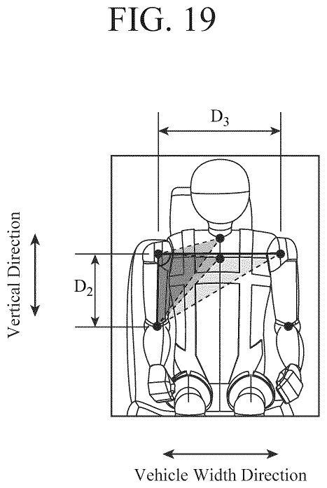

In a case where the occupant keeps the occupant's own arms down as illustrated in FIG. 19, if the skeletal point selected as the third skeletal point is an unselected shoulder skeletal point, the ratio of the distance D₂ to the distance D₃ is about 2:1. As described above, the unselected shoulder skeletal point is the skeletal point that is not selected as the first skeletal point between the skeletal point of the left shoulder portion and the skeletal point of the right shoulder portion.

If the skeletal point selected as the third skeletal point is the first midpoint or the second midpoint, the ratio of the distance D₂ to the distance D₃ is about 1:1.

FIG. 19 is an explanatory diagram illustrating a state in which the occupant keeps the occupant's own arms down.

In a case where the occupant raises the occupant's own arm in the second plane as illustrated in FIG. 16, the distance D₂ in a captured image is shorter than that in the state where the arms are kept down. The distance D₃ in the captured image does not change.

Accordingly, in a case where the occupant raises the occupant's own arm in the second plane, the ratio of the distance D₂ to the distance D₃ is smaller than that in the state where the arms are kept down. The area S of the triangle at this point of time may be smaller than the area S in the state where the arms are kept down.

In a case where the occupant raises the occupant's own arm in the traveling direction, the area S becomes smaller, and therefore, the area S of the triangle may fail to accurately represent the physique P of the occupant.

The area calculating unit 17 acquires, from the skeletal point detecting unit 12, the position coordinates of each of the first skeletal point, the second skeletal point, and the third skeletal point.

The area calculating unit 17 holds information indicating the second threshold Th₂. In a case where the skeletal point selected as the third skeletal point is the unselected shoulder skeletal point, the second threshold Th₂ is a value smaller than ½. In a case where the skeletal point selected as the third skeletal point is the first midpoint or the second midpoint, the second threshold Th₂ is a value smaller than 1.

From the position coordinates of each of the skeletal points, the area calculating unit 17 identifies the distance D₃ between the first skeletal point and the third skeletal point in the captured image, and identifies the distance D₂ between the first skeletal point and the second skeletal point in the captured image.

The area calculating unit 17 then obtains the ratio D₂/D₃ of the distance D₂ to the distance D₃, and determines whether the ratio D₂/D₃ is equal to or higher the second threshold Th₂.

In a case where the ratio D₂/D₃ is equal to or higher than the second threshold Th₂, the area calculating unit 17 calculates the area S of the triangle using the position coordinates, and outputs the result of the calculation of the area S to the physique estimating unit 14.

In a case where the ratio D₂/D₃ is lower than the second threshold Th₂, the area calculating unit 17 does not perform the process of calculating the area S of the triangle. In this case, the process of estimating the physique P is not performed by the physique estimating unit 14.

In the fourth embodiment described so far, the occupant physique detection device 2 shown in FIG. 17 is configured in such a manner that, when the first skeletal point selected by the skeletal point selecting unit 12b is the skeletal point of the left shoulder portion of the occupant while the second skeletal point is the skeletal point of the elbow portion of the left arm of the occupant, or when the first skeletal point selected by the skeletal point selecting unit 12b is the skeletal point of the right shoulder portion of the occupant while the second skeletal point is the skeletal point of the elbow portion of the right arm of the occupant, the area calculating unit 17 calculates the area of the triangle having the first skeletal point, the second skeletal point, and the third skeletal point as the vertices, using the position coordinates of each of the first skeletal point, the second skeletal point, and the third skeletal point, only in a case where the ratio of the distance between the first skeletal point and the second skeletal point in a captured image to the distance between the first skeletal point and the third skeletal point in the captured image is equal to or higher than the second threshold. Thus, like the occupant physique detection device 2 shown in FIG. 1, the occupant physique detection device 2 shown in FIG. 17 can increase the number of states of the occupant from which the physique of the occupant can be estimated to a larger number than that in a conventional case, and also can avoid the process of estimating of the physique in a state with a low estimation accuracy.

### Fifth Embodiment

A fifth embodiment describes an occupant physique detection device 2 including an area correcting unit 18 that corrects the area of a polygon calculated by an area calculating unit 13 on the basis of the distance from a camera 1 to an occupant.

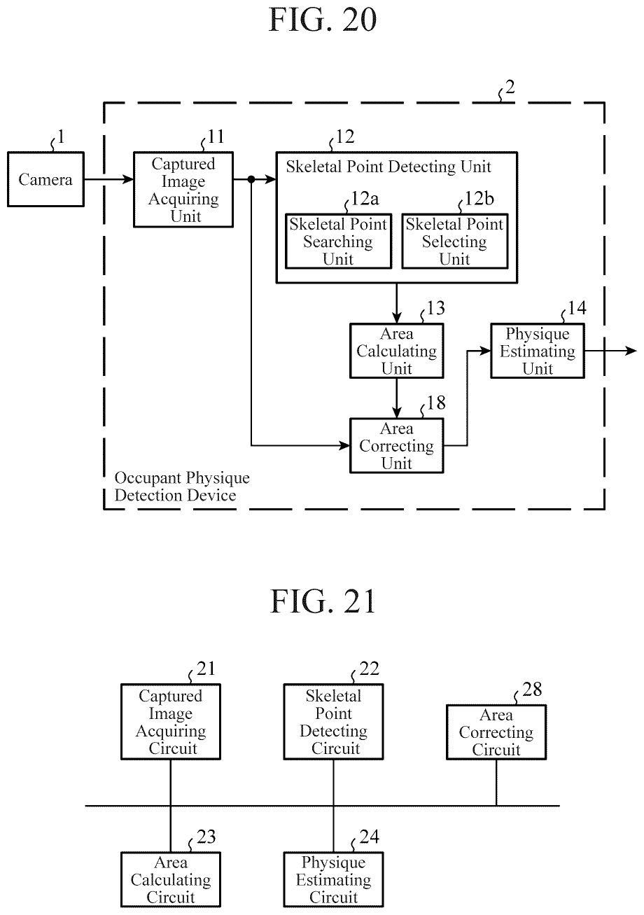

FIG. 20 is a configuration diagram showing the occupant physique detection device 2 according to the fifth embodiment. In FIG. 20, the same reference numerals as those in FIG. 1 denote the same or corresponding components, and therefore, explanation of them is not made herein.

FIG. 21 is a hardware configuration diagram showing the hardware of the occupant physique detection device 2 according to the fifth embodiment. In FIG. 21, the same reference numerals as those in FIG. 2 denote the same or corresponding components, and therefore, explanation of them is not made herein.

The area correcting unit 18 is implemented by an area correcting circuit 28 shown in FIG. 21, for example.

The area correcting unit 18 corrects the area S of a polygon calculated by the area calculating unit 13, on the basis of the distance from the camera 1 to the occupant.

The area correcting unit 18 outputs the corrected area S′ to the physique estimating unit 14.

The occupant physique detection device 2 shown in FIG. 20 is formed by adopting the area correcting unit 18 in the occupant physique detection device 2 shown in FIG. 1. Note that this is merely an example, and the area correcting unit 18 may be adopted in the occupant physique detection device 2 shown in FIG. 8, the occupant physique detection device 2 shown in FIG. 13, or the occupant physique detection device 2 shown in FIG. 17.

In FIG. 20, it is assumed that each of the captured image acquiring unit 11, the skeletal point detecting unit 12, the area calculating unit 13, the physique estimating unit 14, and the area correcting unit 18, which are components of the occupant physique detection device 2, is implemented by dedicated hardware as illustrated in FIG. 21. That is, it is assumed that the occupant physique detection device 2 is implemented by the captured image acquiring circuit 21, the skeletal point detecting circuit 22, the area calculating circuit 23, the physique estimating circuit 24, and the area correcting circuit 28.

Each of the captured image acquiring circuit 21, the skeletal point detecting circuit 22, the area calculating circuit 23, the physique estimating circuit 24, and the area correcting circuit 28 is a single circuit, a composite circuit, a programmed processor, a parallel-programmed processor, an ASIC, an FPGA, or a combination thereof, for example.

The components of the occupant physique detection device 2 are not necessarily implemented by dedicated hardware, but the occupant physique detection device 2 may be implemented by software, firmware, or a combination of software and firmware.

In a case where the occupant physique detection device 2 is implemented by software, firmware, or the like, a program for causing a computer to carry out the processing procedure in each of the captured image acquiring unit 11, the skeletal point detecting unit 12, the area calculating unit 13, the physique estimating unit 14, and the area correcting unit 18 is stored in the memory 31 shown in FIG. 3. The processor 32 shown in FIG. 3 then executes the program stored in the memory 31.

Further, FIG. 21 illustrates an example in which each of the components of the occupant physique detection device 2 is implemented by dedicated hardware, and FIG. 3 illustrates an example in which the occupant physique detection device 2 is implemented by software, firmware, or the like. Note that this is merely an example, and some components in the occupant physique detection device 2 may be implemented by dedicated hardware while the remaining components may be implemented by software, firmware, or the like.

Next, an operation of the occupant physique detection device 2 shown in FIG. 20 is described. Except for the area correcting unit 18, the occupant physique detection device 2 is the same as the occupant physique detection device 2 shown in FIG. 1. Therefore, only the operation of the area correcting unit 18 is described herein.

In the occupant physique detection device 2 shown in FIG. 20, it is assumed that the area S of the polygon calculated by the area calculating unit 13 is the area of the triangle having the three skeletal points as the vertices, for ease of explanation.

The area correcting unit 18 corrects the area S of the triangle calculated by the area calculating unit 13, on the basis of the distance from the camera 1 to the occupant.

The area correcting unit 18 outputs the corrected area S′ to the physique estimating unit 14.

In the description below, the process of correcting the area S to be performed by the area correcting unit 18 is specifically explained.

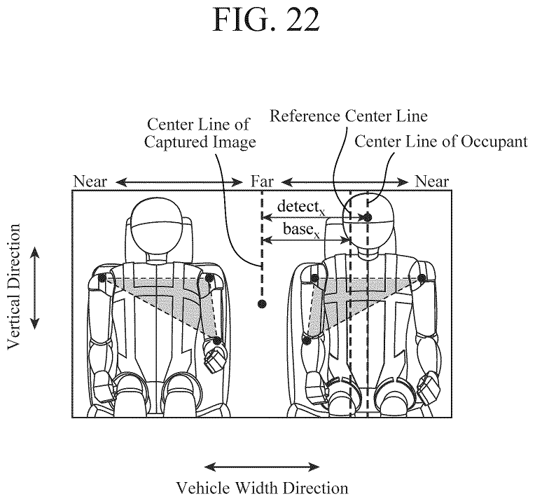

In a case where the camera 1 is disposed near the center of the dashboard in the width direction of the vehicle, for example, if the position at which the occupant is seated is closer to the windshield of the vehicle than an appropriate position in calculating the area S of the triangle, the center line of the occupant moves outward in the captured image as illustrated in FIG. 22. In FIG. 22, the right-side occupant of two occupants has moved in the rightward direction in the drawing, with the center line of the occupant being the outward direction. The center line of an occupant is the line indicating the center portion of the occupant in the width direction of the vehicle. At this point of time, the area in which the occupant is present is enlarged in a captured image.

In a case where the position at which the occupant is seated is closer to the rear window of the vehicle than the appropriate position in calculating the area S of the triangle, the center line of the occupant moves inward in the captured image. In the case of the right-side occupant, the inward direction is the leftward direction in the drawing. At this point of time, the area in which the occupant is present is reduced in a captured image.

FIG. 22 is an explanatory diagram illustrating a state in which an occupant is seated on a side closer to the rear window of the vehicle than the appropriate position in calculating the area S of the triangle.

The area correcting unit 18 stores a distance baseₓ in the vehicle width direction between a reference center line and the center line of a captured image. The reference center line is a center line of the occupant in a case where the position where the occupant is seated is the appropriate position in calculating the area S of the triangle. The distance baseₓ in the vehicle width direction is a distance in the captured image.

The area correcting unit 18 acquires image data from the captured image acquiring unit 11.

The area correcting unit 18 identifies the center line of the occupant shown in the captured image indicated by the image data. Since the process of identifying the center line is a known technique, a detailed explanation thereof is not made herein.

The area correcting unit 18 calculates the distance detects in the vehicle width direction between the identified center line of the occupant and the center point of the captured image. The distance detectₓ in the vehicle width direction is a distance in the captured image.

In a case where the distance detectₓ in the vehicle width direction is shorter than the distance baseₓ, the position at which the occupant is seated is closer to the rear window of the vehicle than the appropriate position in calculating the area S of the triangle. Therefore, the area correcting unit 18 performs correction to expand the area S of the triangle in such a manner that the area S is substantially proportional to the difference between the distance detectₓ and the distance baseₓ, for example.

In a case where the distance detectₓ in the vehicle width direction is longer than the distance baseₓ, the position at which the occupant is seated is closer to the windshield of the vehicle than the appropriate position in calculating the area S of the triangle. Therefore, the area correcting unit 18 performs correction to reduce the area S of the triangle in such a manner that the area S is substantially inversely proportional to the difference between the distance detectₓ and the distance baseₓ, for example.

In a case where the distance detectₓ in the vehicle width direction is the same as the distance baseₓ, the area correcting unit 18 does not perform the process of correcting the area S.

In a case where the area S has been corrected, the area correcting unit 18 outputs the corrected area S′ to the physique estimating unit 14. In a case where the area S has not been corrected, the area correcting unit 18 outputs the area S calculated by the area calculating unit 13 to the physique estimating unit 14 as the corrected area S′ without making any change thereto.

The physique estimating unit 14 acquires the corrected area S′ from the area correcting unit 18.

The physique estimating unit 14 estimates the physique P of the occupant from the corrected area S′.

The physique estimating unit 14 outputs the result of the estimation of the physique P to a control device (not shown) of the vehicle, for example.

In the fifth embodiment described so far, the occupant physique detection device 2 shown in FIG. 20 is configured in such a manner as to include the area correcting unit 18 that corrects the area of a polygon calculated by the area calculating unit 13 on the basis of the distance from the camera 1 to the occupant, and in such a manner that the physique estimating unit 14 estimates the physique of the occupant from the area corrected by the area correcting unit 18. Thus, like the occupant physique detection device 2 shown in FIG. 1, the occupant physique detection device 2 shown in FIG. 20 can increase the number of states of the occupant from which the physique of the occupant can be estimated to a larger number than that in a conventional case, and also can increase the accuracy of physique estimation to a higher level than the occupant physique detection device 2 shown in FIG. 1.

In the occupant physique detection device 2 shown in FIG. 20, the area correcting unit 18 calculates the distance detectₓ as the distance corresponding to the distance from the camera 1 to the occupant. Note that this is merely an example, and the area correcting unit 18 may include a radar, for example, and calculate the distance from the camera 1 to the occupant with the radar.

In this case, if the calculated distance is longer than the reference distance, the area correcting unit 18 performs correction to enlarge the area S of the triangle in such a manner that the area S is substantially proportional to the difference between the calculated distance and the reference distance.

If the calculated distance is shorter than the reference distance, the area correcting unit 18 performs correction to reduce the area S of the triangle in such a manner that the area S is substantially inversely proportional to the difference between the calculated distance and the reference distance.

Note that, in the present disclosure, it is possible to freely combine any of the embodiments, modify any of the components of each of the embodiments, or omit any of the components in each of the embodiments.

### INDUSTRIAL APPLICABILITY

The present disclosure is suitable for an occupant physique detection device and an occupant physique detection method.

### REFERENCE SIGNS LIST

1: camera, 2: occupant physique detection device, 11: captured image acquiring unit, 12: skeletal point detecting unit, 12a: skeletal point searching unit, 12b: skeletal point selecting unit, 13: area calculating unit, 14: physique estimating unit, 15: area calculating unit, 16: area calculating unit, 17: area calculating unit, 18: area correcting unit, 21: captured image acquiring circuit. 22: skeletal point detecting circuit, 23: area calculating circuit, 24: physique estimating circuit, 25: area calculating circuit, 26: area calculating circuit, 27: area calculating circuit, 28: area correcting circuit, 31: memory, 32: processor

1-9. (canceled)

10. An occupant physique detection device comprising:
captured image acquiring circuitry to acquire, from a camera to image an occupant of a vehicle, a captured image showing the occupant;
skeletal point detecting circuitry to detect, from the captured image acquired by the captured image acquiring circuitry, at least three skeletal points that are skeletal points having no obstacles between the camera and the skeletal points and are usable for estimating a physique of the occupant among at least five predetermined skeletal points including skeletal points of both shoulder portions and skeletal points of both waist portions of the occupant, and output position coordinates of each of the at least three skeletal points in the captured image;
area calculating circuitry to calculate an area of a polygon having the skeletal points as vertices, using the position coordinates of each of the skeletal points output from the skeletal point detecting circuitry; and
physique estimating circuitry to estimate the physique of the occupant from the area of the polygon calculated by the area calculating circuitry, wherein the skeletal point detecting circuitry:
searches the captured image acquired by the captured image acquiring circuitry for the at least three skeletal points that are skeletal points having no obstacles between the camera and the skeletal points and are usable for estimating the physique of the occupant among the at least five predetermined skeletal points including the skeletal points of both shoulder portions and the skeletal points of both waist portions of the occupant; and
selects three skeletal points from among the searched at least three skeletal points, and outputs position coordinates of each of the selected three skeletal points in the captured image to the area calculating circuitry.

11. The occupant physique detection device according to claim 10, wherein
the area calculating circuitry calculates an area of a triangle having the skeletal points as the vertices, using the position coordinates of each of the skeletal points output from the skeletal point detecting circuitry; and
the physique estimating circuitry estimates the physique of the occupant from the area of the triangle calculated by the area calculating circuitry.

12. The occupant physique detection device according to claim 10, wherein the skeletal point detecting circuitry
selects, from among the searched at least three skeletal points, one of a skeletal point of a left shoulder portion and a skeletal point of a right shoulder portion of the occupant as a first skeletal point, selects one of a skeletal point of an elbow portion of a left arm and a skeletal point of an elbow portion of a right arm of the occupant as a second skeletal point, and selects one of a midpoint between a left clavicle portion and a right clavicle portion of the occupant, a midpoint between the skeletal point of the left shoulder portion and the skeletal point of the right shoulder portion, or one of the skeletal point of the left shoulder portion and the skeletal point of the right shoulder portion, whichever is not selected as the first skeletal point, as a third skeletal point, and
outputs the position coordinates of each of the first skeletal point, the second skeletal point, and the third skeletal point in the captured image, to the area calculating circuitry.

13. The occupant physique detection device according to claim 12, wherein,
when the first skeletal point selected by the skeletal point detecting circuitry is the skeletal point of the left shoulder portion of the occupant while the second skeletal point is the skeletal point of the elbow portion of the left arm of the occupant, or when the first skeletal point selected by the skeletal point detecting circuitry is the skeletal point of the right shoulder portion of the occupant while the second skeletal point is the skeletal point of the elbow portion of the right arm of the occupant,
the area calculating circuitry calculates the area of the triangle having the first skeletal point, the second skeletal point, and the third skeletal point as the vertices, using the position coordinates of each of the first skeletal point, the second skeletal point, and the third skeletal point, only when an angle formed by a first straight line connecting the first skeletal point and the second skeletal point and a second straight line connecting the first skeletal point and the third skeletal point is within an allowable angular range.

14. The occupant physique detection device according to claim 12, wherein,
when the first skeletal point selected by the skeletal point detecting circuitry is the skeletal point of the left shoulder portion of the occupant while the second skeletal point is the skeletal point of the elbow portion of the left arm of the occupant, or when the first skeletal point selected by the skeletal point detecting circuitry is the skeletal point of the right shoulder portion of the occupant while the second skeletal point is the skeletal point of the elbow portion of the right arm of the occupant,
the area calculating circuitry calculates the area of the triangle having the first skeletal point, the second skeletal point, and the third skeletal point as the vertices, using the position coordinates of each of the first skeletal point, the second skeletal point, and the third skeletal point, only when an angle formed by a first straight line connecting the first skeletal point and the second skeletal point and a third straight line connecting a wrist of an arm of the occupant in which the skeletal point selected as the second skeletal point is present and the second skeletal point is equal to or larger than a first threshold.

15. The occupant physique detection device according to claim 12, wherein,
when the first skeletal point selected by the skeletal point detecting circuitry is the skeletal point of the left shoulder portion of the occupant while the second skeletal point is the skeletal point of the elbow portion of the left arm of the occupant, or when the first skeletal point selected by the skeletal point detecting circuitry is the skeletal point of the right shoulder portion of the occupant while the second skeletal point is the skeletal point of the elbow portion of the right arm of the occupant,
the area calculating circuitry calculates the area of the triangle having the first skeletal point, the second skeletal point, and the third skeletal point as the vertices, using the position coordinates of each of the first skeletal point, the second skeletal point, and the third skeletal point, only when a ratio of a distance between the first skeletal point and the second skeletal point in the captured image to a distance between the first skeletal point and the third skeletal point in the captured image is equal to or higher than a second threshold.

16. The occupant physique detection device according to claim 10, further comprising
area correcting circuitry to correct the area of the triangle calculated by the area calculating circuitry on a basis of a distance from the camera to the occupant, wherein
the physique estimating circuitry estimates the physique of the occupant from the area corrected by the area correcting circuitry.

17. An occupant physique detection method comprising:
acquiring, from a camera to image an occupant of a vehicle, a captured image showing the occupant;
searching the acquired captured image for at least three skeletal points that are skeletal points having no obstacles between the camera and the skeletal points and are usable for estimating a physique of the occupant among at least five predetermined skeletal points including skeletal points of both shoulder portions and skeletal points of both waist portions of the occupant, selecting three skeletal points from among the searched at least three skeletal points, and outputting position coordinates of each of the selected three skeletal points in the captured image;
calculating an area of a triangle having the skeletal points as vertices, using the output position coordinates of each of the skeletal points; and
estimating the physique of the occupant from the calculated area of the triangle.
